(19) United States
(12) Patent Application Publication
(10) Pub. No.: US 2016/0055233 A1
(43) Pub. Date: Feb. 25, 2016

(54) PRE-JOIN TAGS FOR ENTITY-RELATIONSHIP MODELING OF DATABASES

(71) Applicant: CA, Inc., Islandia, NY (US)

(72) Inventors: Zheng WANG, Beijing (CN); Jinbao ZHU, Beijing (CN); Yunzhen LIN, Beijing (CN); Feng HUANG, Beijing (CN); Nannan CAO, Beijing (CN)

(21) Appl. No.: 14/467,822

(22) Filed: Aug. 25, 2014

(51) Int. Cl. G06F 17/30

(52) U.S. Cl. CPC G06F 17/30604; G06F 17/30498

(57) ABSTRACT

Join-queried entities are selectively linked in an entity-relationship model of the database by defining a pre-join tag in the entity-relationship model of the database and selectively providing the pre-join tag between join-queried entities in the entity-relationship model of the database. Frequently join-queried entities in the entity-relationship model of the database may be identified, and a pre-join tag may be provided between the frequently join-queried entities. A non-relational database may be generated from the entity-relationship model by creating merged entities in the non-relational database based on the pre-join tags. A relational database may be generated from the entity-relationship model by selectively creating merged entities in the relational database based on the pre-join tags.

### BACKGROUND

Various embodiments described herein relate to computer systems, methods and program products and, more specifically, to database management computer systems, methods and program products.

DataBase Management Systems (DBMSs) are specially designed software applications that interact with users, other applications and a database itself, to capture and analyze data. More specifically, a DBMS may allow the definition, creation, querying, update and administration of databases. Commercially available DBMSs include MySQL, PostgreSQL, SQLite, Microsoft SQL Server, Microsoft Access, Oracle, SAP, dBASE, FoxPro, IBM DB2, LibreOffice Base and FileMaker Pro.

Databases may be divided into relational databases and non-relational databases, based upon their organization. A relational database is a database that has a collection of tables of data items, which are formally described and organized according to a relational model. Data in a single table represents a relation. Moreover, tables may have additionally defined relationships with each other. In the relational model, each table schema identifies a column or group of columns, called the primary key, to uniquely identify each row. A relationship can then be established between a row in the table and a row in another table, by creating a foreign key, i.e., a column or group of columns in one table that points to a primary key of another table. Many relational databases are designed and implemented using Structured Query Language (SQL), so that relational databases may also be called SQL databases. SQL-based relational database management systems are presently provided by many vendors.

In contrast, a non-relational database, also referred to as a “Not Only SQL” or a “NoSQL” database, provides a mechanism for storage and retrieval of data that is modeled using techniques other than tabular relations used in relational databases. Non-relational databases may be more simple in design and may provide better horizontal scaling compared to relational databases. A non-relational database may also be referred to as a “hierarchical database”, because the data elements are provided in a hierarchy rather than using table relationships. Non-relational databases are finding significant and growing use in big data and real-time Web applications. Non-relational databases include column-based databases, such as Accumulo, Cassandra and HBase; document-based databases, such as Clusterpoint, Couchbase, MarkLogic and MongoDB; key-value-based databases, such as Dynamo, FoundationDB, MemcacheDB, Redis, Riak and FairCom c-treeACE; and graph-based databases, such as Allegro, Neo4J, OrientDB and Virtuoso.

Database design is a process for producing a database. A DBMS may facilitate database design. Database design may generally include three overall operations: conceptual modeling of the database, logical modeling of the database and physical design of the database. In conceptual modeling, a database modeling computer system, method and/or program product is used to identify relationship dependencies within the data to be stored in the database. In logical modeling, a logical structure of a database may be defined using, for example, keys, domains and/or data types. Once the database is conceptually and logically modeled, the physical design of the database can specify the physical configuration of the database in a storage media. The physical design may be performed by a database creation system. Common DBMSs may include both a database modeling system for the conceptual and/or logical modeling and a database creation system, although these functionalities may also be separately provided by separate systems.

A database may be designed using an Entity-Relationship (ER) model, which is a data model for describing a database in an abstract way. In ER modeling, an entity may be defined as a thing which is recognized as being capable of an independent existence and which can be uniquely identified. In English grammar structure, an entity may be thought of as a “noun”. A relationship captures how entities are related to each other. Thus, relationships can be thought of as “verbs”, linking two or more nouns. Entities and relationships can both have attributes, which may be thought of as “adjectives” for entities, and “adverbs” for relationships.

### BRIEF SUMMARY

Various embodiments described herein can selectively link join-queried entities in an entity-relationship model of a database. The selective linking may be performed by defining a pre-join tag in the entity-relationship model of the database and selectively providing a respective pre-join tag between respective join-queried entities in the entity-relationship model of the database. In some embodiments, frequently join-queried entities in the entity-relationship model of the database are identified, and a respective pre join tag is provided between the respective frequently join-queried entities in the entity-relationship model of the database. The frequently join-queried entities may be identified by identifying join-queried entities that comprise a comprise a join-queried frequency that exceeds a threshold.

In some embodiments, prior to the linking of the frequently join-queried entities in the entity-relationship model of the database, the frequently join-queried entities are identified. Various techniques may be used to identify the frequently join-queried entities. In some embodiments, a non-relational database is mined to identify frequently occurring structures therein. In other embodiments, frequently occurring queries are identified from query logs of the database, entities that are associated with the frequently occurring queries are identified, and the frequently join-queried entities are identified from the frequently occurring queries and from the entities that are associated with the frequently occurring queries.

In some embodiments when the database is a non-relational database, the frequently join-queried entities may be identified from reverse key tables. In other embodiments when the database is a non-relational database, the frequently join-queried entities may be identified from composite keys. In still other embodiments when the database is a relational database, the frequently join-queried entities may be identified by identifying runtime joins that are performed on the relational database in response to queries.

In some embodiments, a non-relational database may be generated from the entity-relationship model by creating merged entities in the non-relational database based on the selective linking. The generating may be performed by creating an embedded structure in the non-relational database based on the merged entities and/or by creating a composite key in the non-relational database based on the merged entities.

In other embodiments, a relational database is generated from the entity-relationship model by selectively creating merged entities in the relational database based on the selective linking. The merged entities may be created by selectively merging two tables in the relational database based on the merged entities.

Other embodiments can selectively link frequently join-queried entities in an entity-relationship model of a relational database by identifying, from query logs of the relational database, tables that are frequently joined at run time in response to queries of the relational database; identifying entities that are associated with the tables that are frequently joined; and providing a respective pre-join tag between the respective entities that are associated with the tables. The entity-relationship model of the relational database including the pre-join tags may be converted into a non-relational database. The converting may take place by creating merged entities in the non-relational database based on the pre join tags. The frequently occurring queries may be executed on the non-relational database using the merged entities.

Various embodiments described herein may provide an apparatus that comprises processor circuitry and memory circuitry coupled to the processor circuitry and comprising computer readable program code, such as a database management system, that, when executed by the processor circuitry, causes the processor circuitry to perform operations comprising selectively linking join-queried entities in an entity-relationship model of a database according to any of the embodiments described herein. Other embodiments provide methods of selectively linking frequently join-queried entities in an entity-relationship model of a database according to any of the embodiments described herein, wherein the generating is performed by processor circuitry. Still other embodiments provide a computer program product that comprises a computer-readable storage medium having computer readable program code embodied in the medium that, when executed by processor circuitry of a computer system, causes the computer system to perform operations comprising selectively linking join-queried entities in an entity-relationship model of a database according to any of the embodiments described herein.

It is noted that aspects described with respect to one embodiment may be incorporated in different embodiments although not specifically described relative thereto. That is, all embodiments and/or features of any embodiments can be combined in any way and/or combination. Moreover, computer equipment, systems, methods, and/or computer program products according to embodiments will be or become apparent to one with skill in the art upon review of the following drawings and detailed description. It is intended that all such additional computer equipment, systems, methods, and/or computer program products be included within this description and protected by the accompanying claims.

### BRIEF DESCRIPTION OF THE DRAWINGS

The accompanying drawings, which are included to provide a further understanding of the present disclosure and are incorporated in and constitute a part of this application, illustrate certain embodiment(s). In the drawings:

FIG. 1 is a block diagram of a computer system, method and/or computer program product according to various embodiments described herein.

FIGS. 2-8 are flowcharts of operations that may be performed by a database management system according to various embodiments described herein.

FIG. 9 illustrates an example of a join query of two tables in a relational database.

FIG. 10 illustrates an example of a document in a non-relational database.

FIG. 11 illustrates an example of merging of two collections into a multiple collection in a non-relational database.

FIG. 12 illustrates an example of distribution of a non-relational database in a computing environment.

FIG. 13 illustrates an entity-relational model in a relational database (left side) and a pre join collection in a non-relational database (right side), including gaps therebetween, according to various embodiments described herein.

FIG. 14 illustrates an example of an entity-relationship diagram with a pre-join tag according to various embodiments described herein.

FIG. 15 illustrates translated tables for the entity-relationship diagram of FIG. 14, without the pre-join tag, on a physical database.

FIG. 16 illustrates translations of the tables of FIG. 14 on the physical database in a multi-to-multi table.

FIG. 17 illustrates a pre-join table for the tables of FIG. 14.

FIG. 18 illustrates runtime joining in relational databases.

FIG. 19 illustrates a merging of a collection in a non-relational database.

FIG. 20 is another entity-relationship diagram including pre join tags according to various embodiments described herein.

FIG. 21 is a flowchart of operations to identify join queries from query logs according to various embodiments described herein.

FIG. 22 is a flowchart of operations to identify frequently join-queried entities according to various embodiments described herein.

FIG. 23 is a flowchart of operations that may be used to generate a database using the pre join tags according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

### Introduction

Various embodiments described herein can allow join-queried entities in an entity-relationship model of a database to be selectively linked. As used herein, a “join” is an operation that combines records from two or more tables in a relational database or combines two or more collections in a non-relational database. A “join-query” is a query, the performance of which requires data from two or more tables in a relational database or from two or more collections in a non-relational database.

The selective linking may be performed using a pre-join tag between respective join-queried entities in the entity-relationship model of the database. In some embodiments, the selective linking may identify frequently join-queried entities in the entity-relationship model of the database and providing a respective pre join tag between the respective frequently join-queried entities in the entity-relationship model of the database. Frequently join-queried entities may be identified by identifying join-queried entities in the entity-relationship model of the database that comprise a join-query frequency that exceeds a threshold.

If the database is a relational database, the pre-join tags may be used to reduce the number of runtime join-queries that need be performed. Moreover, the pre-join tags may be used to convert the relational database into a non-relational database or to merge the relational database with a non-relational database, by creating merged entities in the non-relational database based on the pre-join tags. If the database is a non-relational database, the pre-join tags may also be used to improve query performance by creating merged entities in the non-relational database based on the pre-join tags. Improved querying of join-queried entities may thereby be provided.

Various embodiments described herein may arise from a recognition that a traditional entity-relationship model includes entities with attributes, relationships and keys, but does not allow the database modeler to link frequently join-queried entities in the entity-relationship model. In a database, querying of data related to different entities may use a “join” clause or other query form. However, execution of a join clause in a database may generate large numbers of input/output operations resulting in slow performance. Moreover, in non-relational databases, join queries are extremely difficult to execute.

In sharp contrast, various embodiments described herein allow a pre-join tag to be associated with entities that are frequently join-queried, so as to link the frequently join-queried entities in the entity-relationship model of the database. At the database creation phase, a physical model can be automatically created to enhance join queries by selectively merging entities into a common table or a common collection, in response to the pre join tags. Accordingly, physical models may be built that can reduce input/output costs for queries across multiple database tables or collections, and thereby allow improved query performance in a database management system.

### High Level Description

A high level description of various embodiments described herein will now be provided using block diagrams and flowcharts.

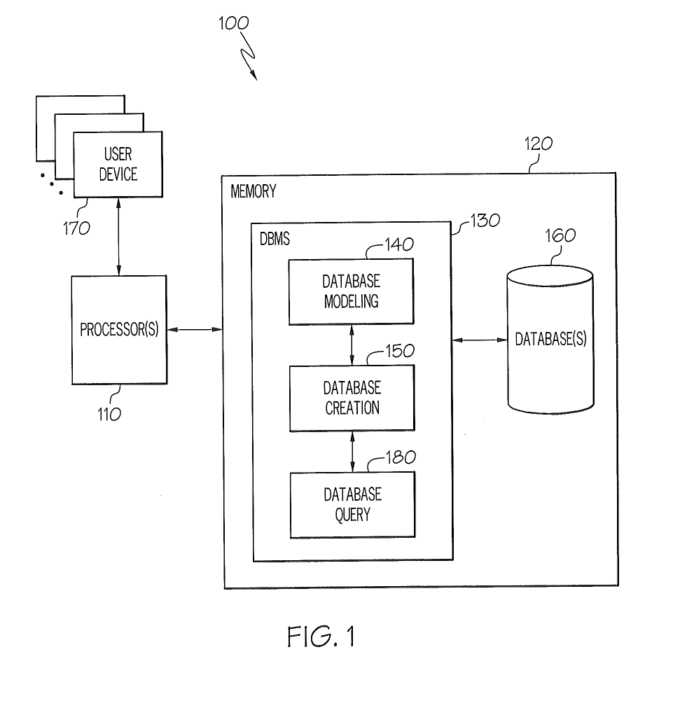

FIG. 1 is a block diagram of a computer system, method and/or program product that can provide a DataBase Management System (DBMS) according to various embodiments described herein. Referring to FIG. 1, a computer system 100 may be embodied by one or more enterprise, application, personal, pervasive and/or embedded computer systems that are operable to receive, transmit, process and store data using any suitable combination of software, firmware and/or hardware, and that may be standalone or interconnected by any conventional public and/or private, real and/or virtual, wired and/or wireless network including all or a portion of the global communication network known as the Internet, and may include various types of tangible, non-transitory computer-readable media. One or more processors 110 communicate with one or more memories 120 that may be a combination of any one or more tangible computer-readable media. User input/output devices 170 may include output devices, such as a graphical display and/or loudspeaker, and input devices, such as a keyboard, touch screen, mouse and/or microphone. The processor 110, the memory 120 and the input/output devices 170 may communicate with one another over one or more buses and/or using other computer architectures. The user devices 170 may also be connected to the processor 110 directly or by any conventional public and/or private, real and/or virtual wired and/or wireless network including all or a portion of the global communication network known as the Internet.

A DBMS 130 may be stored in the memory 120. The DBMS 130 may be used to provide the definition, creation, querying, update and administration of one or more databases 160. The database(s) 160 may communicate with the DBMS 130 directly and/or may be connected to the DBMS 130 by any conventional public and/or private, real and/or virtual wired and/or wireless network including all or a portion of the global communication network known as the Internet. The database(s) 160 may be stored in a common memory 120 with the DBMS 130, as illustrated in FIG. 1, or they may be stored in different memories.

Still referring to FIG. 1, the DBMS 130 may include a database modeling computer system, method and/or program product 140, a database creation computer system, method and/or program product 150, and/or a database query computer system, method and/or program product 180. The DBMS 130 may also include an administration system and/or other functionality. The database modeling system 140, the database creation system 150 and the database query system 180 may be provided by a single vendor as part of a DBMS or may be provided by different vendors.

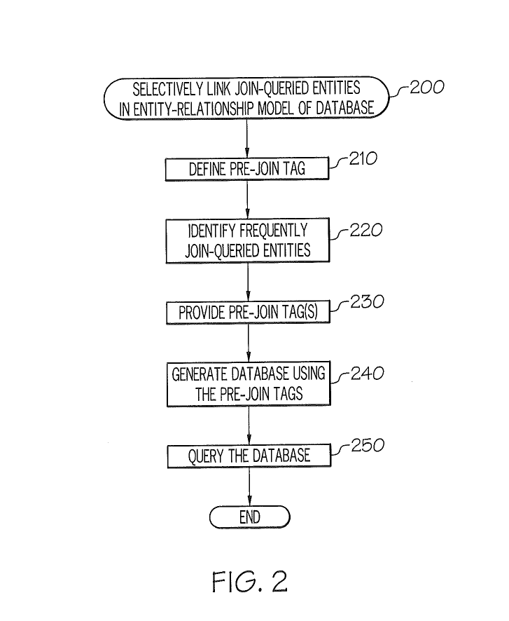

FIG. 2 is a flowchart of operations that may be performed by a DBMS, such as the DBMS 130 of FIG. 1, according to various embodiments described herein. Referring to FIG. 2, these operations 200 selectively link join-queried entities in an entity-relationship model of a database.

Specifically, referring to FIG. 2, at Block 210, a pre-join tag is defined in the entity-relationship model of the database. The pre join tag may be used to link frequently join-queried entities in the entity-relationship model of the database. Thus, at Block 210, the entity-relationship model includes entities, relationships, attributes and pre-join tags. As used herein, a “tag” is an additional, optional description in an entity-relationship model which can record data characteristics and/or query characteristics for the model. Tags are not mapped to a physical table or a column in a relational database. Rather, they describe data characteristics and/or query characteristics. The pre join tag may be thought of as a list which records the join query characteristics for the entity-relationship model.

At Block 220, frequently join-queried entities are identified. In general, join-queried entities in the entity-relationship model of the database that comprise a pre join frequency that exceeds a threshold, may be identified. Various techniques for identifying frequently join-queried entities will be described below in connection with FIGS. 2-8. It will be understood that the operations of Blocks 210 and 220 may be performed in reverse order from that shown in FIG. 2.

Referring to Block 230, a respective pre-join tag is selectively provided between respective join-queried entities in the entity-relationship model of the database, for example based upon the frequently join-queried entities that are identified. Thus, the frequently join-queried entities are linked in the entity-relationship model of the database. The operations of Blocks 210-230 may be performed, for example by a database modeling system 140.

Referring to Block 240, the database may then be generated or created, for example by a database creation system 150, using the pre-join tags that are included in the entity-relationship model of the database. Finally, at Block 250, queries may then be executed on the database that was generated using the pre join tags. The queries may be executed, for example, by the database query system 180 of FIG. 1.

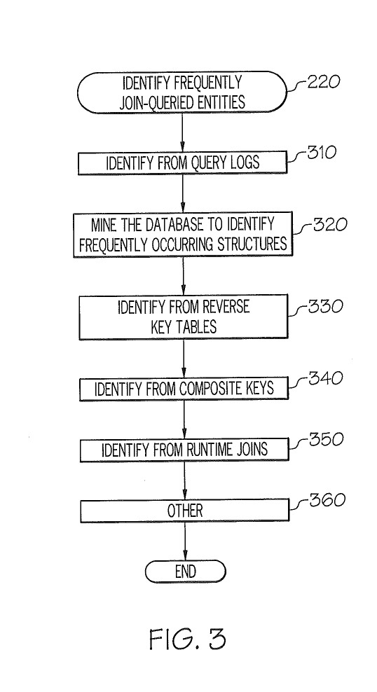

FIG. 3 is a flowchart of operations that may be used to identify frequently join-queried entities, which may correspond to Block 220 of FIG. 2. Any combination or subcombination of the operations described in FIG. 3 may be used to identify frequently join-queried entities, in any sequence.

For example, at Block 310, query logs may be used to identify queries in which joined entities are used. Frequency of occurrence of these queries may then be determined, and those queries which have a frequency of occurrence that exceeds a threshold, such as a highest frequency occurrence, may be identified as candidates for linking by pre join tags. In other embodiments, as illustrated at Block 320, a non-relational database may be mined to identify frequently occurring structures therein, which then may be candidates for pre join tags. At Block 330, in a non-relational database, frequently join-queried entities may be identified from reverse key tables and/or at Block 340, frequently join-queried entities may be identified in a non-relational database from composite keys. At Block 350, in a relational database, runtime joins that are performed on the relational database in response to queries may be identified, and those runtime joins that are frequently performed, for example which exceed a given threshold, may be candidates for pre-join tags. Finally, at Block 360, other techniques may also be used to identify frequently join-queried entities.

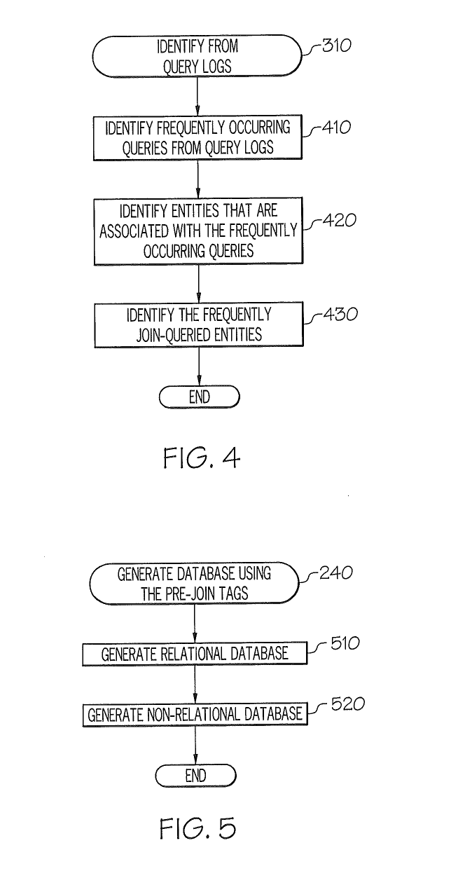

FIG. 4 is a flowchart of operations that may be performed to identify the frequently join-queried entities in the entity-relationship model of the database from query logs, which may correspond to Block 310 of FIG. 3. Specifically, referring to FIG. 4 at Block 410, frequently occurring queries are identified from the query logs of the database. At Block 420, entities that are associated with the frequently occurring queries are identified. Finally, at Block 430, the frequently join-queried entities are identified from the frequently occurring queries that were identified at Block 410 and from the entities that are associated with the frequently occurring queries at Block 420.

FIG. 5 is a flowchart of operations for generating or creating a database from the entity-relationship model using the pre-join tags, which may correspond to Block 240 of FIG. 2. As illustrated in FIG. 5, a relational database may be generated from the entity-relationship model and/or at Block 520, a non-relational database may be generated. In either operation, the generation may also include merging the generated database with an existing database.

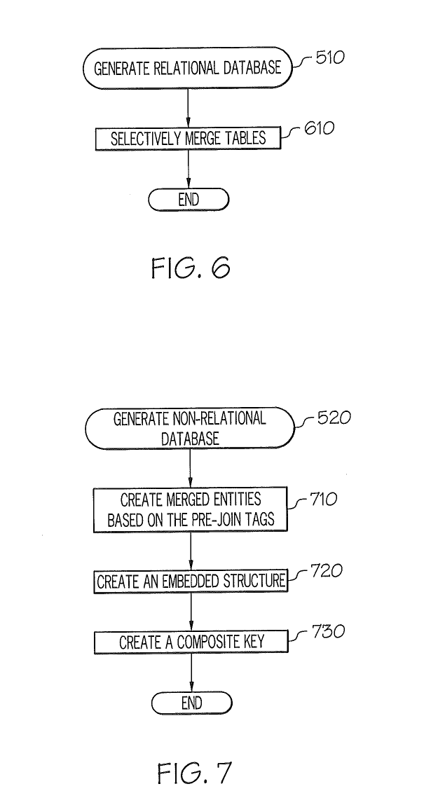

FIG. 6 is a flowchart of operations that may be performed to generate a relational database using the pre-join tags, which may correspond to Block 510 of FIG. 5. Referring to FIG. 6, at Block 610, tables in the relational database may be selectively merged based on the pre-join tags. This selective merging can reduce the number of runtime joins that are needed in a relational database.

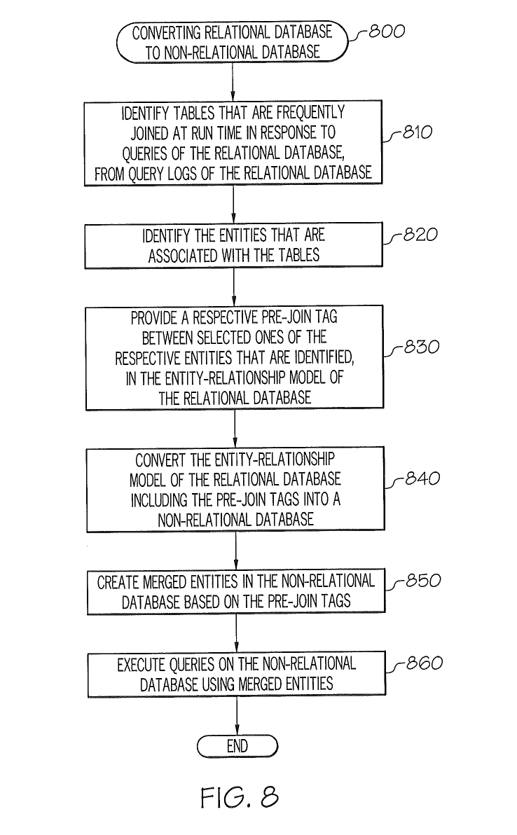

FIG. 7 is a flowchart of operations that may be performed to generate a non-relational database using the pre-join tags, which may correspond to Block 520 of FIG. 5. Referring to FIG. 7, at Block 710, merged entities may be created in the non-relational database based on the pre-join tags. At Block 720, an embedded structure may be created in the non-relational database based on the merged entities. Moreover, at Block 730, a composite key may be created in the non-relational database based on the merged entities.

More specifically, an “embedded structure” and a “composite key” are both structures that may be used by a NoSQL database to perform pre-join. However, not all NoSQL databases can perform an “embedded structure” and not all NoSQL databases can perform a “composite key”. Many NoSQL databases can perform an “embedded structure”, and a “composite key” may be used in column-based databases, such as HBase. Some embodiments may only choose one method in a NoSQL database.

An “embedded structure” is a structure that stores one entity into another. For example, assume the entity “Student” and the entity “Class”. They may appear as follows in a document database:

Class:
{

id:xxx
name:xxx
type:xxx

}
Student:
{

id:xxx
name:xxx
age:xxx
in_which_class:xxx

}

For a pre-join tag, it may be desirable to query the Student entity together with the Class entity, such as “get class with its related students”. In a NoSQL database, for example, a document database, the Student entity can be stored in the Class entity, as follows:

Class:
{

id:xxx
name:xxx
type:xxx

Students:
[
{

id:xxx
name:xxx
age:xxx
in_which_class:xxx

},
{

id:xxx
name:xxx
age:xxx
in_which_class:xxx

},
.........
]
}

Since these two entities are stored together, by an embedded structure, the pre-join tag can be performed.

In another example, in HBase, each row has a row-key, and in an HBase table, all rows are sorted according to row keys. It is easier to get adjacent rows in one query in HBase. Using the example above, Class and Student entities are merged into one HBase table and then the Class id or name is stored into the row-key. Other information also may be stored in the row key, such as time stamp, etc., so it may be referred to as a “composite row key”. A composite row key can make a query easier. The table structure will be as shown in the following Table, which assumes Class A has id 1, B has 2, C has 3:

TABLE

| Row-key | The Class column family | | The student column family | | |
|---|---|---|---|---|---|
| (class id) | Name | type | id | name | age |
| 1 + original | Class A | xx | 101 | xx | xx |
| Hbase row key | | | | | |
| 1 + original | Class A | xx | 102 | xx | xx |
| Hbase row key | | | | | |
| 1 + original | Class A | xx | 103 | xx | xx |
| Hbase row key | | | | | |
| 2 + original | Class B | xx | 202 | xx | xx |
| Hbase row key | | | | | |
| 2 + original | Class B | xx | 201 | xx | xx |
| Hbase row key | | | | | |
| 3 + original | Class C | xx | 302 | xx | xx |
| Hbase row key | | | | | |
| . . . | . . . | . . . | . . . | . . . | . . . |

FIG. 8 is a flowchart of operations that may be performed to convert a relational database to a non-relational database according to various embodiments described herein. These operations 800 may correspond to a specific use case of the operations of FIG. 2, which may be used to allow improved query performance when converting a relational database to a non-relational database.

Referring to FIG. 8, at Block 810, tables that are frequently joined at run time in response to queries of the relational database, are identified from query logs of the relational database. At Block 820, entities that are associated with the tables are then identified. At Block 830, a respective pre-join tag is provided between respective entities that are associated with the tables. At Block 840, the entity-relationship model of the relational database including the pre-join tags is converted into a non-relational database. At Block 850, merged entities are created in the non-relational database based on the pre-join tags. Finally, at Block 860, queries are executed on the non-relational database using the merged entities.

### Low Level Description

A low level description of various embodiments described herein will now be provided, along with working examples. These examples shall be regarded as merely illustrative and shall not be construed as limiting the invention.

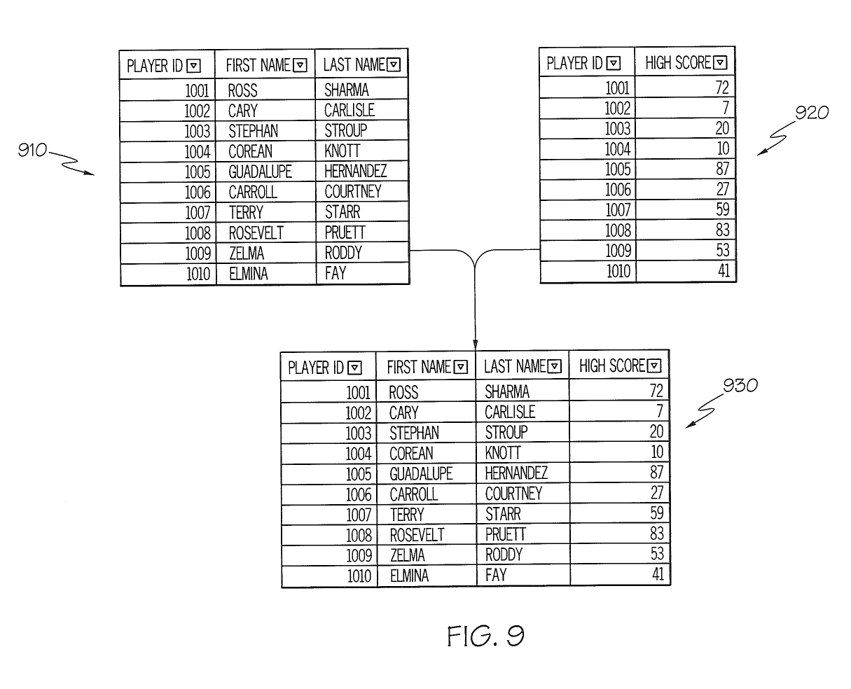

Specifically, FIG. 9 illustrates an example of a join-query as used in a relational database. A join query (also referred to as a “join”), is a query that is made from more than one physical table in a relational database. For example, in FIG. 9, Table 910 is a “Player Id” table, including a player's first and last name, whereas Table 920 is a “High Score” table that relates a Player Id and a high score for that Player Id. If a query is made as to high scores based on a player name, the Tables 910 and 920 may be joined at run time, as illustrated schematically by Table 930, in order to obtain the results of the join query. It will be understood, however, that Table 930 is only provided for illustration, but a physical table is not created in the relational database from the join query. Thus, a join query is a technique to query from multiple tables corresponding to multiple entities in an entity-relationship model.

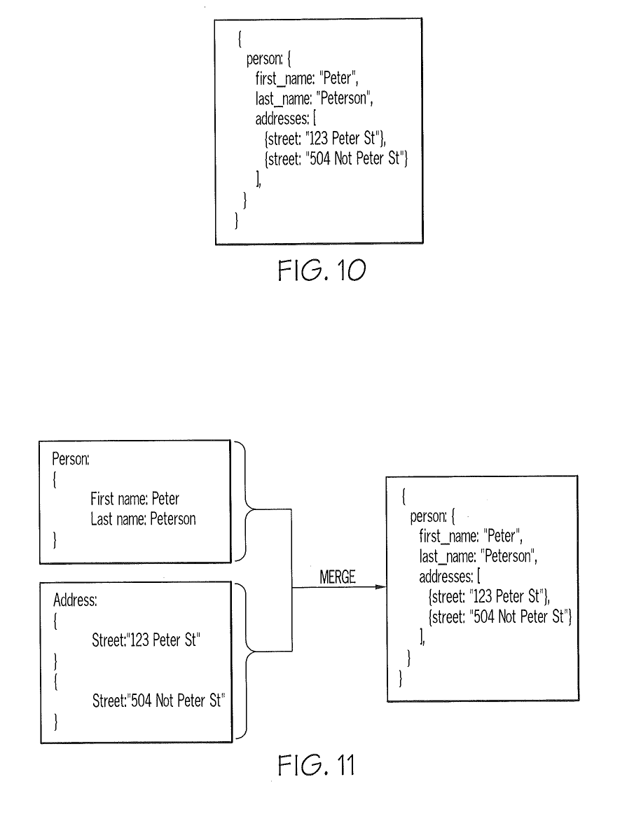

In contrast, when it is desired to query from multiple collections or entities in a non-relational database, a runtime join is generally not a practical choice, as it may be very inefficient to do a runtime join in non-relational databases. Non-relational databases are becoming increasingly popular. As was noted above, non-relational databases often have a hierarchical structure, as illustrated in the example of FIG. 10, which illustrates a typical document in a non-relational database. As shown in FIG. 10, the document has a hierarchical structure with numerous hierarchical fields, thus making this structure suitable for big databases. However, these non-relational databases do not have a table-like structure.

It is often desirable to query from multiple collections or entities in a non-relational database. This query may be accomplished by merging one collection into another, to build a new physical collection in the non-relational database. For example, as illustrated in FIG. 11, the “Person” collection and the “Address” collection may be merged to form a merged collection that includes the name and address of the person. This merged collection may be referred to as a “pre join” collection. Unfortunately, however, in a non-relational database, in order to query multiple collections, the merged or pre-join collection must be made at database creation, rather than at database run time. Stated differently, in a non-relational database, a new collection generally must be built before a query can be made. There generally is no runtime join as is generally present in relational databases.

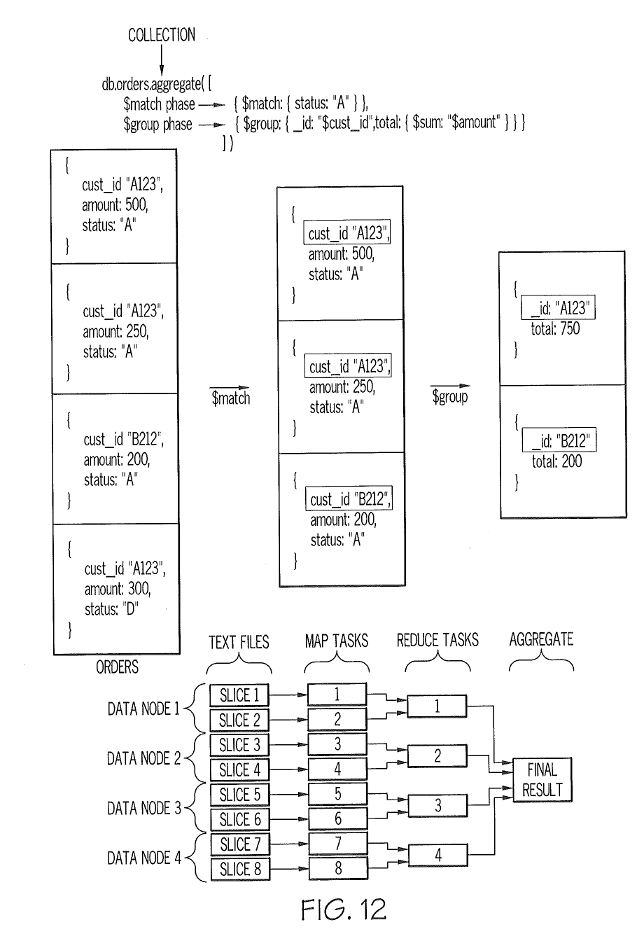

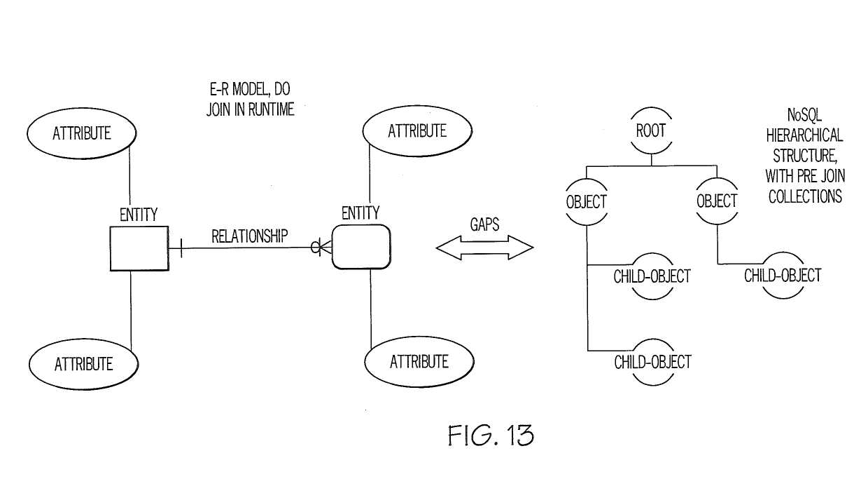

FIG. 12 provides an example of why it is difficult to provide a runtime join in non-relational databases. Specifically, FIG. 12 shows how queries are executed on a NoSQL database. Since NoSQL databases are often distributed, they are deployed on different physical machines. Thus, when a query is run on NoSQL, it may be distributed to different physical machines, illustrated in FIG. 12 as “DATA NODE1 . . . DATA NODE 4”. For example, to run an aggregate query, the query may need to be divided to different machines, searched in textfiles stored in each machine, perform distributed computing and combine the results together to finally get the desired result. If a join query is needed to be run, since different data from different machines needs to be joined, the amount of map tasks and join data from different machines may cause a large data transfer between machines. Finally, in most real-world NoSQL systems, joins are not supported.

Accordingly, as illustrated in FIG. 13, there are gaps between the different join techniques that are available in a relational database and a non-relational database. Specifically, relational databases, which are often based on traditional entity-relationship models, may perform a query from multiple tables using a runtime join query. In contrast, in non-relational databases, a multi-collection query may only be performed by forming a pre join collection at database creation.

As was described in the High Level Description above, various embodiments described herein can selectively link join-queried entities, such as frequently join-queried entities, in an entity-relationship model of a database. In some embodiments, the selective linking is provided by defining a pre join tag, and selectively providing a respective pre-join tag between respective frequently join-queried entities in the entity-relationship model of the database. A specific example will now be provided.

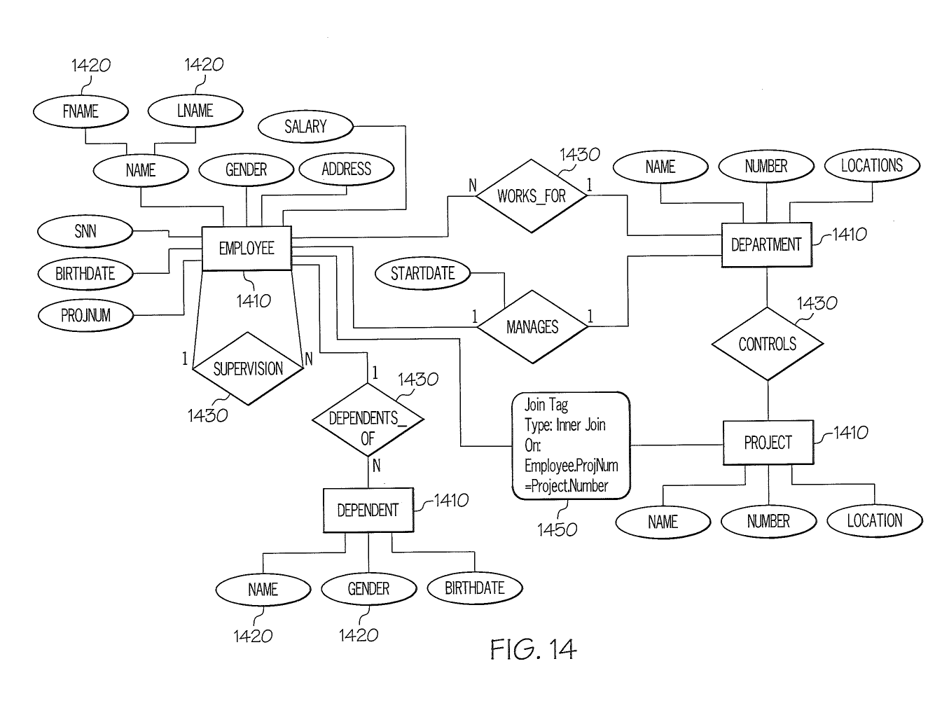

FIG. 14 illustrates an entity-relationship diagram including a pre-join tag according to various embodiments described herein. The entity-relationship diagram of FIG. 14 includes four entities 1410: EMPLOYEE, DEPENDENT, DEPARTMENT and PROJECT, represented by a rectangle in FIG. 14. Each entity may produce a table in a relational database. Each entity also includes attributes 1420, represented by ovals in FIG. 14. Various relationships 1430 are also selectively defined among the entities 1410, as indicated by diamonds in FIG. 14. In addition, as shown in FIG. 14, a pre join tag 1450 is also defined that links the EMPLOYEE entity and the PROJECT entity. The pre-join tag 1450 between the EMPLOYEE entity and the PROJECT entity may be provided because there are frequent join queries between these two tables. As shown in the pre-join tag 1450, the type of join is an inner join having an ON clause wherein the project number of the EMPLOYEE table and the Number column of the PROJECT table is provided.

A detailed explanation of an “ON clause” will now be provided. Since a join query is a query over two entities, an ON clause is a clause in a join query to figure out how to put these two entities together. For example, assume a Class entity with properties ID, Name and Type, and a Student entity with properties ID, Name, Age and In_Class_ID. A query may be performed over these two tables with a join query: “Select Class.Name as className, Student.Name as studentName from Student join Class on Student.In_Class_ID=Class.ID”. This join query will query over two tables and get student's name with its related class name. The ON clause is “on Student.In_Class_ID=Class.ID”. The On clause shows that Student entity and Class entity are put together. When they have the same value on Student.In_Class_ID and Class.ID, then Class.Name is selected as “className, Student.Name as studentName” as the result.

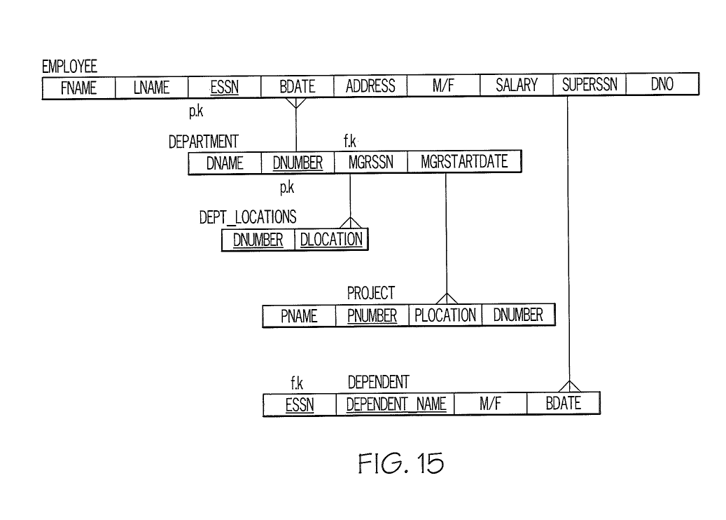

FIG. 15 illustrates translated tables on a physical database for the entity-relationship diagram of FIG. 14, before adding the pre join tag. The primary key for each table is denoted by “p.k” and the foreign key for each table is denoted by “f.k”. As is known to those having skill in the art, keys define relationships between tables in a relational database. A primary key uniquely specifies a tuple within a table. While natural attributes (attributes used to describe the data being entered) are sometimes good primary keys, surrogate keys are often used. A surrogate key is an artificial attribute assigned to an object, which uniquely identifies it. In contrast, a foreign key is a field or collection of fields in one table that uniquely identifies a row of another table. In other words, a foreign key is a column or a combination of columns that is used to establish and enforce a link between two tables. With a foreign key, two tables in a relational database can have a closer relationship and can be easier for querying and modifying. Thus, in a relational database, two tables with a foreign key may be more likely to occur in a join query. However, two tables without foreign keys may also occur frequently in a join query.

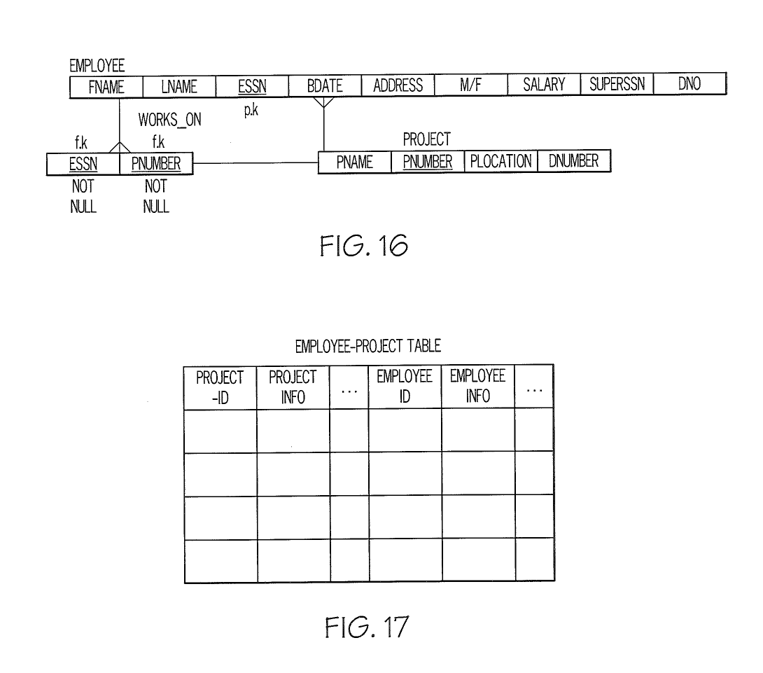

Referring back to FIG. 14, a query may be performed by combining the EMPLOYEE and PROJECT tables to determine which employees are working on a given project or on which project a given employee is working. In a relational database, this query may be implemented by performing an SQL script at run time, which may state, for example, “Select employee, project from employee join projects where in the same department”. Alternatively, as shown in FIG. 16, if there are frequent queries that combine the EMPLOYEE and PROJECT tables, an extra multi-to-multi relationship table (WORKS_ON) may be created to make the query easier. Stated differently, a multi-to-multi relationship may be created in the entity-relationship model, as shown in FIG. 16.

In yet another alternative, a pre join table may be built, for example as illustrated in FIG. 17 for the EMPLOYEE-PROJECT table.

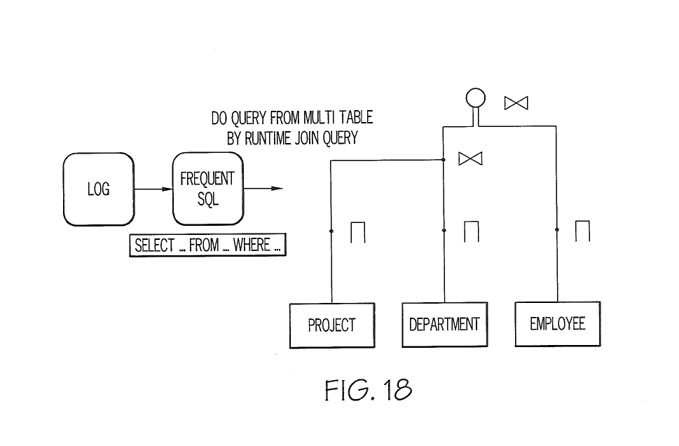

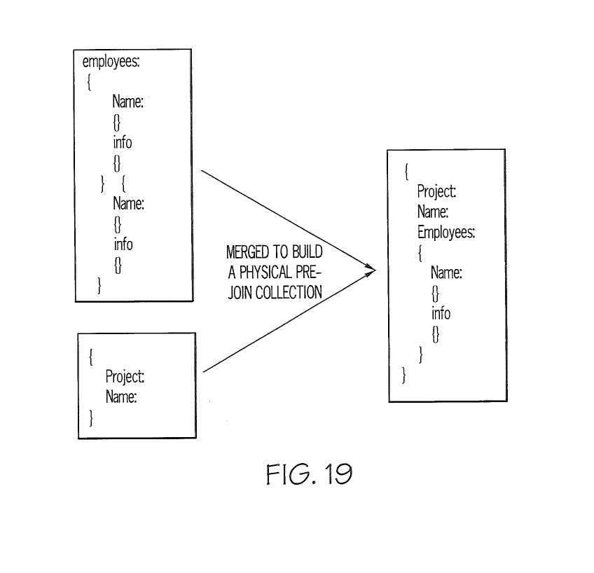

As shown in FIG. 18, runtime joins are built into SQL scripts and may be run when needed. Moreover, as shown in FIG. 19, in a non-relational database, join query tables can be translated into a pre-join table, as was described above in connection with FIG. 11.

Thus, to deal with join queries in relational databases, a join may be performed during the query (runtime join) or a join query may be performed by defining an N-N (multi-to-multi) relationship table. Unfortunately, however, since joins are not supported in non-relational databases, these non-relational databases may only have an opportunity to represent joins in a pre-join collection. Pre join collections may be established in non-relational databases manually. Unfortunately, this may be a cumbersome and incomplete process.

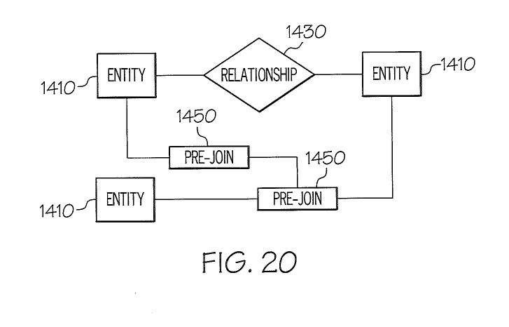

In sharp contrast, various embodiments described herein may allow an entity relationship model to be used on a different physical production environment, such as a non-relational database, by linking frequently join-queried entities in the entity-relationship model of the database. Thus, by adding pre-join characteristics to the entity-relationship model, the entity-relationship model may appear as illustrated in FIG. 20. In FIG. 20, the attributes are not shown for simplicity.

To summarize, traditional entity-relationship models generally do not have the ability to include pre-join characteristics, so that they are not suitable to generate proper physical models that can automatically fit different physical environments with pre-join characteristics. Non-relational databases are widely used for data storage and data analysis. Non-relational databases generally are schema-free or schemaless. Thus, when data modelers need to migrate data between non-relational databases and a traditional relational database, they may need to define or extract the schema of the non-relational database manually. Moreover, existing transform tools for data and schema transform may ignore the data characteristics. However, since collections in non-relational database may have different characteristics, especially pre-join, these characteristics may have an important impact on the transformation. As schemaless data storage, non-relational databases may store relations between entities, but this relation may not be explicit. Non-relational databases may store the relationships as embedded collections, or may not store the relationships, but just may store the entities. Thus, when migrating data and structure from relational databases to non-relational databases, modelers may need to redesign the entity relationship structure to ensure efficiency of the target database. Accordingly, besides the data structure itself, pre-join characteristics may also be relevant for data and schema migration. Since traditional entity models do not include elements representing pre join characteristics, manual structure redesign may be needed to fit for the different environment when migrating.

In sharp contrast, various embodiments described herein can add a pre-join tag in the traditional entity-relationship model, as a new model element. The pre join characteristics can help to generate proper physical models that can automatically fit different physical environments. Data modelers can build models with pre-join data tags and/or extract the model from existing databases. The model can then be transformed to different physical models of databases.

Pre-join tags according to various embodiments described herein may be used during model definition (which may correspond to Block 210 of FIG. 2), model generation (which may correspond to Blocks 220-230 of FIG. 2), database generation (which may correspond to Block 240 of FIG. 2) and/or database querying (which may correspond to Block 250 of FIG. 2).

In model definition, as was already described above, a database model such as illustrated in FIG. 14 may be defined based on the standard entity-relationship model with entities 1410, properties or attributes 1420, and relationships 1430 between entities. Various embodiments described herein can selectively add pre-join tags 1450 between entities to reference columns to mark the pre-join option. The pre-join tags can signify that a join query may frequently call on the referenced entities and columns. This may be the case whether or not there is a foreign key in the relational database.

Once the pre-join tags are defined (for example as was described at Block 210), frequently join-queried entities are then identified, for example as was described at Block 220. Frequently join-queried entities may be defined manually by modelers and/or may be generated automatically from relational or non-relational databases. Different techniques may be used to discover pre joined tags in relational and non-relational databases, as was previously illustrated in FIG. 6.

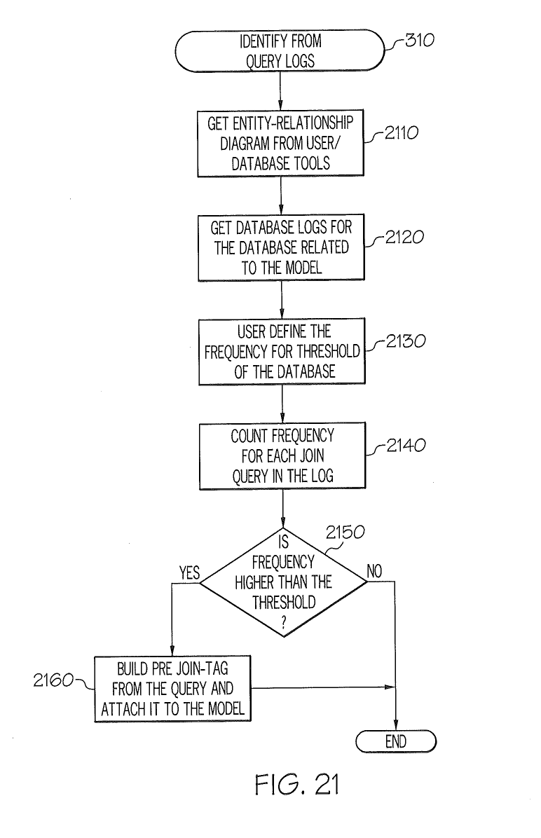

For relational databases, pre-join tags may be generated by mining database query logs, as was generally described at Block 310 of FIG. 3 and at FIG. 4. Specifically, referring to FIG. 21, at Block 2110, the entity-relationship diagram may be obtained from the user and/or from database tools. Database query logs for the database are obtained at Block 2120. A frequency threshold that is used to define frequently join-queried entities may be defined by the user and/or by the system at Block 2130. The threshold may be expressed as an absolute number of queries and/or a percentage of total queries, and this threshold may be constant or may change over time and/or based on other factors, such as the size of the database. Other techniques for defining a fixed or variable threshold may be used. At Block 2140, for each join query in the query log, the frequency is counted, and at Block 2150, if the frequency is higher than the threshold, a pre join tag is built from the query at Block 2160 and attached to the model, as was illustrated, for example, in FIG. 14. It will also be understood that in other embodiments, pre-join tags may be assigned by a user manually.

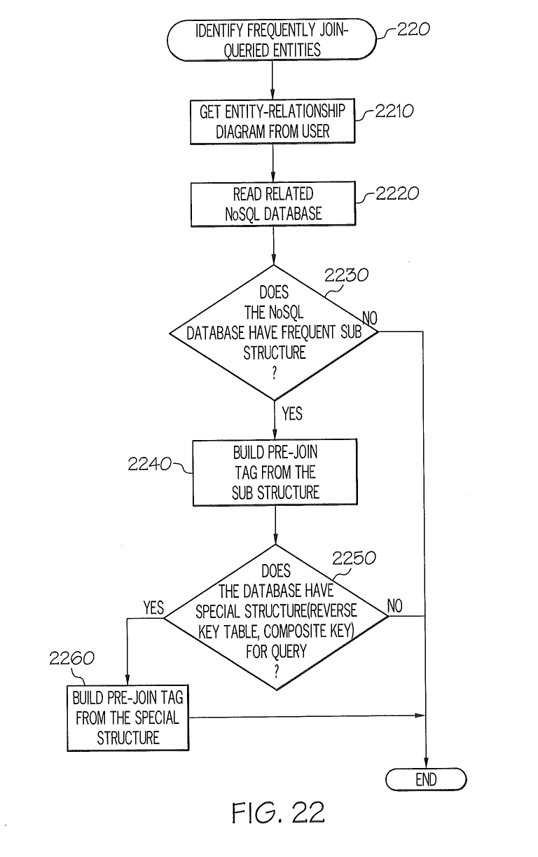

Other techniques may be used to generate a model from a non-relational database, as was described, for example, at Blocks 320-340 of FIG. 3. FIG. 22 provides an example of operations that may be performed on a non-relational (NoSQL) database, to mine the structure of the non-relational database and identify frequently join-queried entities. At Block 2210, the entity-relationship diagram for the non-relational database is obtained, and at Block 2220, the non-relational database is read. At Block 2230, a determination is made as to whether the non-relational database has a frequent sub-structure, as will be described in detail below. One example of a frequent sub-structure is an embedded document in the MongoDB DBMS. If Yes, then at Block 2240, the sub-structure can be converted to pre join tags.

A frequent sub-structure, or frequently embedded structure, is a structure that frequently occurs in a NoSQL collection. For example, assume a NoSQL collection Class. Since NoSQL databases may be schemaless, there may be different structures in one NoSQL collection. Specifically, there may be some documents without sub-structure, like:

Class:
{

id:xxx
name:xxx
type:xxx

}

and there may be some documents with sub-structure, like:

Class:
{

id:xxx
name:xxx
type:xxx

Students:
[
{

id:xxx
name:xxx
age:xxx
in_which_class:xxx

},
{

id:xxx
name:xxx
age:xxx
in_which_class:xxx

},
.........
]
}

If documents with sub-structures occur frequently in a collection (the threshold may be set by users), a determination may be made that there is a frequent sub-structure in the collection.

Moreover, at Block 2250, a determination is made as to whether the database has a special structure, such as a reverse key table or a composite key for query. If so, at Block 2260, pre-join tags are built from the special structure. Specifically, some non-relational databases have reverse key tables for indexing and optimizing join queries. A mining process can be performed to recover the pre-join tags from these tables. Moreover, some non-relational databases may have composite keys for indexing and optimizing join queries. A mining process can be done to recover these pre join tags from these keys, as well. It will be understood that the operations of Blocks 2230 and 2250 may be performed out of the order shown in FIG. 22.

Still other techniques may be used. For example, an entity-relationship model may be present and multiple non-relational databases may be related to this entity-relationship model, with no relational databases related to this entity-relationship model. In this case, pre-join tags may be mined from one or more non-relational databases, attached to the entity-relationship model, and then deployed for one or more of the other non-relational databases.

Finally, different strategies may be generated for data migration or schema building using pre-join tags. For example, when a model with pre join tag between two entities needs to be converted into a physical structure of a non-relational database, non-relational embedded structure can be built for query optimization, composite keys can be built, and/or two tables can be merged. In more detail, pre join tags may be used when an entity-relationship model of a relational database is applied to anon-relational database, as was illustrated, for example, in FIG. 8. The pre-join tags can allow structure to be built into the non-relational database, so as to perform the pre-join. Non-relational databases may use hierarchical or embedded structures to perform pre-joins. This, these structures can be built using the pre join tag. Other non-relational databases may use other techniques to perform pre join, such as composite keys. The pre join tags can also be used with composite keys.

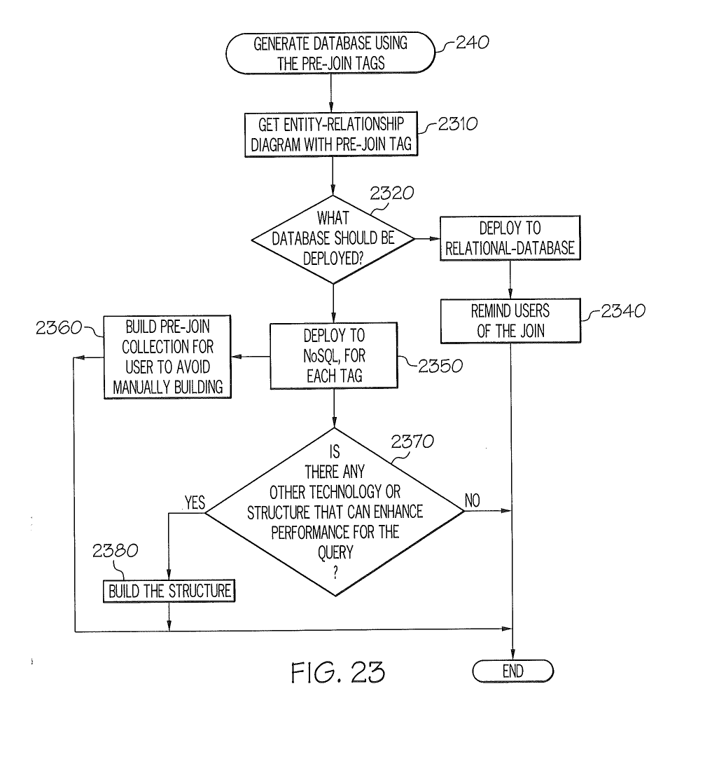

FIG. 23 provides an example of creating merged entities in a non-relational database based on the pre-join tags, which may correspond to Block 240 of FIG. 2 and which also may correspond to Block 850 of FIG. 8. At Block 2310, the entity-relationship diagram with the pre join tags is obtained. At Block 2320, a determination is made as to what type of database is being created. At Block 2330, if a relational database, then the pre-joins may be added to the relational database, to reduce the number of pre-joins that are needed at run time, and users may be reminded of the join at Block 2340. On the other hand, if a non-relational database is being created at Block 2350, then a pre join collection may be built at Block 2360, to avoid the need for manually building such a collection. Moreover, at Block 2370, if there is other technology or structure that can enhance performance of the query, as was described above, then the structure is also built at Block 2380.

Accordingly, by adding pre-join characteristics that represent join queries to the entity relationship model, computation and applications can be generated at the physical production environment data level and need to decide how to deploy the entity relationship model on physical environments of a relational or non-relational database.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “circuitry,” “module,” “component,” and/or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or otherwise structured to do so. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A method comprising:
selectively linking join-queried entities in an entity-relationship model of a database.

2. A method according to claim 1 wherein the selectively linking comprises:
selectively providing a respective pre join tag between respective join-queried entities in the entity-relationship model of the database.

3. A method according to claim 2 wherein the selectively linking further comprises:
identifying frequently join-queried entities in the entity-relationship model of the database; and
providing the respective pre-join tag between the respective frequently join-queried entities in the entity-relationship model of the database.

4. A method according to claim 3 wherein the identifying frequently join-queried entities in the entity-relationship model of the database comprises:
identifying join-queried entities in the entity-relationship model of the database that comprise a join-query frequency that exceeds a threshold.

5. A method according to claim 1 wherein the selectively linking comprises:
identifying frequently join-queried entities in the entity-relationship model of the database; and
linking the frequently join-queried entities in the entity-relationship model of the database.

6. A method according to claim 5 wherein the database is a non-relational database and wherein the identifying frequently join-queried entities in the entity-relationship model of the database comprises:
mining the non-relational database to identify frequently occurring structures therein.

7. A method according to claim 5 wherein the identifying frequently join-queried entities in the entity-relationship model of the database comprises:
identifying frequently occurring queries from query logs of the database;
identifying entities that are associated with the frequently occurring queries; and
identifying the frequently join-queried entities from the frequently occurring queries and from the entities that are associated with the frequently occurring queries.

8. A method according to claim 5 wherein the database is a non-relational database and wherein the identifying frequently join-queried entities in the entity-relationship model of the database comprises:
identifying the frequently join-queried entities from reverse key tables.

9. A method according to claim 5 wherein the database is a non-relational database and wherein the identifying frequently join-queried entities in the entity-relationship model of the database comprises:
identifying the frequently join-queried entities from composite keys.

10. A method according to claim 5 wherein the database is a relational database and wherein the identifying comprises:
identifying the frequently join-queried entities in the entity-relationship model of the database by identifying runtime joins that are performed on the relational database in response to queries.

11. A method according to claim 1 further comprising:
generating a non-relational database from the entity-relationship model, wherein the generating comprises creating merged entities in the non-relational database based on the selectively linking.

12. A method according to claim 11 wherein the generating comprises:
creating an embedded structure in the non-relational database based on the merged entities.

13. A method according to claim 11 wherein the generating comprises:
creating a composite key in the non-relational database based on the merged entities.

14. A method according to claim 1 further comprising:
generating a relational database from the entity-relationship model, wherein the generating comprises selectively creating merged entities in the relational database based on the selectively linking.

15. A method according to claim 14 wherein the generating further comprises:
selectively merging tables in the relational database based on the merged entities.

16. A method according to claim 1 wherein the database is a relational database and wherein the selectively linking comprises:
identifying, from query logs of the relational database, tables that are frequently joined at run time in response to queries of the relational database;
identifying entities that are associated with the tables; and
providing a respective pre join tag in the entity-relationship model of the relational database, between respective entities that are associated with the tables.

17. A method according to claim 16 further comprising:
converting the entity-relationship model of the relational database including the respective pre-join tags into a non-relational database.

18. A method according to claim 17 wherein the converting comprises:
creating merged entities in the non-relational database based on the respective pre-join tags.

19. A method according to claim 18 further comprising:
executing queries on the non-relational database using the merged entities.

20. An apparatus comprising:
processor circuitry; and
memory circuitry coupled to the processor circuitry and comprising computer readable program code that when executed by the processor circuitry causes the processor circuitry to perform operations comprising:
selectively linking join-queried entities in an entity-relationship model of a database.

21. A computer program comprising:
a computer readable storage medium comprising computer readable program code embodied in the medium that when executed by processor circuitry of a computer system causes the computer system to perform operations comprising:
selectively linking join-queried entities in an entity-relationship model of a database.
